(19) United States
(12) Patent Application Publication
(10) Pub. No.: US 2005/0153091 A1
(43) Pub. Date: Jul. 14, 2005

(54) Product Labeling System with Overwrapped Printed Article

(75) Inventors: William Reynolds Challoner, Greenbay, WI (US); Daniel R. Fulwiler, Algoma, WI (US); Chauncey T. Mitchell JR., Lakeland, TN (US)

Correspondence Address: Stephen B. Salai, Esq.;Harter, Secrest & Emery LLP, 1600 Bausch & Lomb Place, Rochester, NY, 14604-2711, US

(73) Assignee: WS PACKAGING GROUP, INC., Algoma, WI (US)

(21) Appl. No.: 10/905,179

(22) Filed: Dec. 20, 2004

Related U.S. Application Data
(60) Provisional application No. 60/531,358, filed on Dec. 19, 2003.

(51) Int. Cl. B32B 9/00

(52) U.S. Cl. 428/42.3

(57) ABSTRACT

A product labeling system for overwrapping printed articles on products includes a web having product-labeling information being visible at an outer surface of the web. A succession of base substrates is positioned along the continuous length of the web, and a permanent adhesive bonds the base substrates to an inner surface of the web. Printable substrates are mounted on the succession of base substrates and are held in place by a temporary adhesive. Successive lengths of the web are separated into discrete sections and wrapped around products such that the product labeling information remains visible on the outside of the products and the printable substrates are located between the wrapped web sections and the products.

### BACKGROUND OF THE INVENTION

The invention relates to multi-layer laminate constructions of product wraps such as used for labeling bottles and cans. Typically, the product wraps wrap entirely around the product containers and display printed information about the products. In accordance with the invention, printed articles are temporarily bonded to the interior of the product wraps so that the printed articles reach the product purchaser and cannot be casually removed prior to sale.

Product wraps are produced in a web form from continuous lengths of printable materials including both paper and film. Product information is printed in a repeating fashion along the length of the web and the printed lengths of the web are wrapped around product containers and adhered to themselves to provide surrounding labels. The web materials are chosen with respect to the environment in which the packaging is expected to be exposed. For example, films are used where the product is expected to be exposed to moisture.

Marketing demands have led to the development of more complex labels, including multi-part labels having detachable parts such as coupons, game pieces, prizes, collectibles, and other promotional articles. For example, so-called piggyback labels involve mounting one label on another, so a base label remains with the product and a top label is removable for its intended further use.

Labels with detachable parts, however, are subject to premature detachment where products are exposed to public inspection and handling prior to sale. Coupons and other promotional articles of perceived value can be removed prior to sale, which deprives the marketer of the products with the intended communication to the purchasers and deprives the purchasers of the products with the intended benefits of the promotion. Products labeled by product wraps are often sold in environments open to public inspection and handling.

### SUMMARY OF THE INVENTION

The invention in one or more embodiments mounts printed articles inside product wraps that surround product containers such as bottles and cans. The printed articles are preferably mounted directly or indirectly on interior surfaces of the product wraps prior to applying the product wraps to the product containers. As such, the printed articles are protected against casual removal prior to the purchase of the products on which the printed articles are mounted. The product wraps must be significantly removed or destroyed to reach the printed articles.

One embodiment of the invention for a product labeling system with overwrapped printed articles includes a web having a continuous length and inner and outer surfaces. Product labeling information is visible at the outer surface of the web. A succession of base substrates is positioned along the continuous length of the web. A first adhesive permanently bonds the base substrates to the inner surface of the web. Printable substrates are mounted on the succession of base substrates. A second adhesive temporarily bonds the printable substrates to the base substrates on the inner surface of the web. Successive lengths of the web are separable into discrete sections for wrapping around products such that the product labeling information remains visible on the products and the printable substrates are located between the wrapped web sections and the products.

The second adhesive can be a dry release adhesive so that the printable substrates can be separated from the base substrates without retaining a tacky residue from the temporary adhesive. Such printable substrates having a clean release can be arranged as coupons, scratch-offs, giveaways, collectible cards, web or net decoders, and other printed promotional articles. Alternatively, the second adhesive can be a pressure-sensitive adhesive that is used together with a release layer on the base substrates so that the printed articles can be separated from the base substrates and remounted on another substrate. These printed articles can function as transferable labels and can be used as stickers, seals, reminders, shipping labels, or game pieces that are mountable on game boards. The second adhesive can also be pattern coated to assist in the removal of the printed substrates. The base and printed substrates can also be die cut to different area dimensions for similar purposes.

Another embodiment of the invention for a product labeling system with promotional article includes a film web having outer and inner surfaces a repeating printed pattern along a continuous length. The printed patterns are visible on the outer surface of the film web for labeling products. A succession of printable film substrates having front and back surfaces are positioned along the length of the web in registration with the repeating printed patterns. The back surface of the printable film substrate is treated together with the inner surface of the film web to generate a static electric bond for securing the printable film substrates to the inner surface of the film web.

The film web can be wound together with the succession of printable film substrates into a roll, and the front surface of the printable film substrates can be treated to avoid statically bonding with the outer surface of the film web so that the printable film substrates remain statically bonded to the inner surface of the film web when the film web is later unrolled for labeling products. In this regard, successive lengths of the unrolled film web can be separated into discrete sections in registration with the printed patterns. The web sections can be wrapped around products such that the product patterns remain visible on the products and the printable film substrates are located between the wrapped web sections and the products.

An embodiment of the invention as a method of labeling products includes advancing along a first in-line apparatus both a wrapping web having a continuous length and inner and outer surfaces and a liner web having a continuous length and a succession of printed articles distributed along the continuous length of the liner web. Printed patterns are visible on the outer surface of the wrapping web for labeling products. The printed articles are transferred from the liner web to the wrapping web by bonding the printed articles to the inner surface of the wrapping web. The wrapping web together with the bonded printed articles is advanced along a second in-line apparatus. The wrapping web is separated into discrete sections each containing at least one of the printed articles. The discrete web sections are wrapped around products such that the printed patterns remain visible on the products and the printable articles are located between the wrapped web sections and the products.

The printed articles can include base substrates temporarily mounted on the liner web and printable substrates temporarily mounted on the base substrates. After transfer the base substrates are preferably permanently bonded to the inner surface of the wrapping web.

Another embodiment of the invention as a product wrapping system includes a printed label wrap that is wrapped around a circumference of a product. An outer surface of the label wrap is oriented remote from the product for presenting printed information about the product. An inner surface of the label wrap is oriented adjacent to the product. A printed article is temporarily bonded to the inner surface of the label wrap and is located between the label wrap and the product so that the label wrap must be permanently altered to detach at least a portion of the printed article from the inner surface of the label wrap.

The label wrap preferably includes a length having two ends that are bonded together to secure the label wrap to the product. The printed article can be made visible through the label wrap, such as by using a transparent label wrap.

The printed article is preferably accessible by at least partially removing the label wrap from the product. Generally, this is expected to involve tearing the wrap away from the product. Lines of peroration or weakening can be formed in the label wrap to assist its removal. Any intended tearing or other damage to the label wrap is preferably apart from the label, which can be used to reinforce a portion of the wrap.

### BRIEF DESCRIPTION OF THE SEVERAL VIEWS OF THE DRAWINGS

FIG. 1 is a front view of a bottle and a label wrap around a circumference of the bottle.

FIG. 2 is a cut-away length of the unwound label wrap showing a printed article mounted on an inter surface of the label wrap.

FIG. 3 is an enlarged cross-sectional view through a label wrap and one version of the printed article having a so-called piggyback construction with a clean release substrate.

FIG. 4 is an enlarged cross-sectional view through a label wrap and another version of the printed article having a so-called piggyback construction with a pressure-sensitive adhesive substrate.

FIG. 5 is an enlarged cross-sectional view through a label wrap and another version of the printed article attached directly to the label wrap using a static electric charge.

FIG. 6 is a diagram of an in-line apparatus for constructing printed articles on a liner web.

FIG. 7 is an exploded cross-sectional view showing the application of layers for constructing the printed articles on the liner web.

FIG. 8 is an enlarged cross-sectional view showing one of the printed articles on the liner web.

FIG. 9 is a diagram of an inline apparatus for transferring the printed articles from the liner web to a wrapping web.

FIG. 10 is a diagram of an inline label wrapping apparatus for separating the wrapping web into label wraps and for applying the label wraps to products for positioning the printed articles between the label wraps and the products.

### DETAILED DESCRIPTION OF THE INVENTION

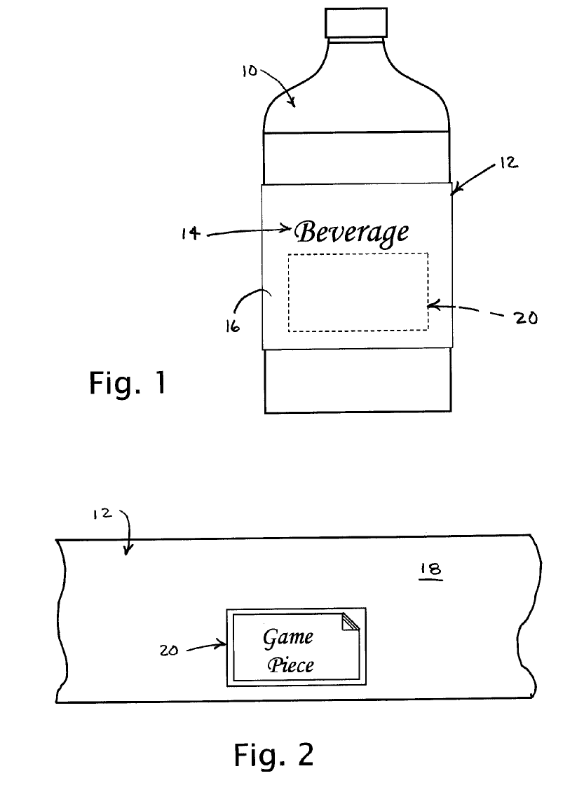

Referring to FIG. 1, an exemplary product or product container in the form of a bottle 10 has a label wrap 12 surrounding an entire circumference of the bottle 10. Product labeling information 14 is visible on an outer surface 16 of the label wrap 12. A printed article 20 is shown in phantom line beneath the label wrap 12. Heat sealing and other forms of attachment can also be used for securing the label wrap 12 securely to the bottle 10. In addition, the label wrap 12 can be applied as a heat-shrinkable sleeve.

As more clearly seen in FIG. 2, the printed article 20 is mounted on an inner surface 18 of the label wrap 12. If the label wrap 12 is transparent, the product labeling information 14 can be printed on either the outer surface 16 or the inner surface 18 of the label wrap 12. A variety of flexible materials, including paper and film materials, can be used to form the label wrap 12. However, materials that are not damaged by water are preferably used for wrapping the bottle 10. Examples of such materials include polymer films such as polypropylene, polyester, and polyolefin, single or multi-ply. A one or two-ply co-extruded propylene can also be used for this purpose. Similar flexible materials can be used to form the printed articles 20, which in the present embodiment must also survive exposure to water.

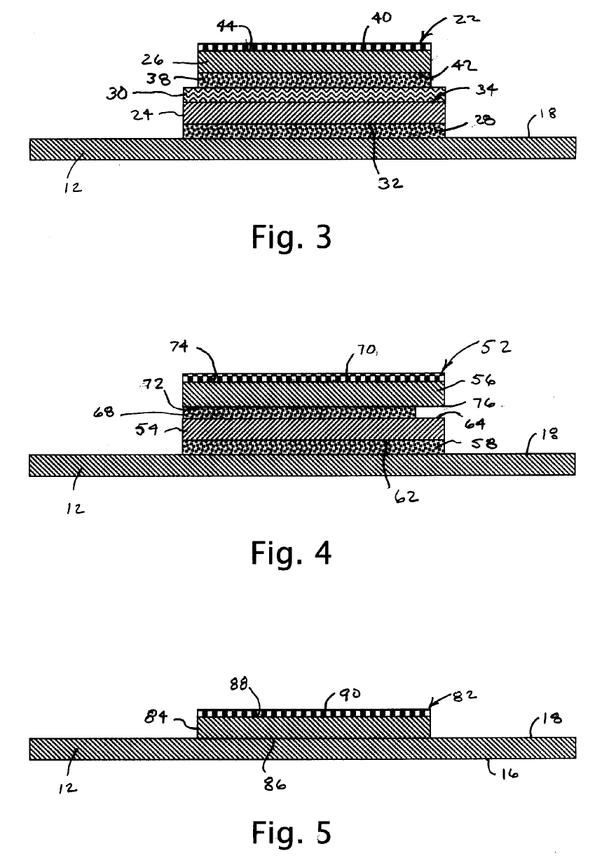

The printed article 20 can take a variety of forms exemplified by alternative constructions shown in FIGS. 3 through 5. In FIG. 3, a printed article 22 includes both a base substrate 24 and a printable substrate 26. A pressure-sensitive adhesive layer 28 is carried on a bottom surface 32 of the base substrate 24, and a release layer 30 is carried on a top surface 34 of the base substrate 24. Another pressure-sensitive adhesive layer 38 is carried on a bottom surface 42 of the printable substrate 26, and a print layer 40 is carried on a top surface 44.

Both the base substrate 24 and the printable substrate 26 are preferably made of thin flexible materials to avoid interfering with the wrapping function of the label wrap 12. Both substrates 24 and 26 also preferably withstand at least incidental exposure to water. Similarly, the pressure-sensitive adhesive layers 28 and 38 are preferably formed by water-insoluble adhesives, such as rubber-based hot melts or acrylics. However, the adhesive layer 28 preferably forms a permanent bond with the inner surface 18 of the label wrap 12, while the adhesive layer 38 cooperates with the release layer 30 to form a temporary bond between the base substrate 24 and the printable substrate 26.

The print layer 40 is also preferably printed with water-compatible inks and includes graphics or other printed information that defines the function of the printed article 22. The printable substrate 26, together with its pressure-sensitive adhesive layer print layer 38 and its print layer 40, forms a detachable portion of the printed article 22 that can be later removed from the base substrate 24 and remounted on another substrate. The pressure-sensitive adhesive layer 38 can form a permanent bond with another substrate. Prior to mounting on the inner surface 18 of the label wrap 12, the pressure-sensitive adhesive layer 28 and form a temporary bond with a release liner (not shown) on which the printed articles 22 are constructed. Both the base and printable substrates 24 and 26 can be die cut against the release liner to a first dimension encompassing a first area, and the printable substrate 26 can be die cut against the base substrate 24 to a second dimension encompassing a second smaller area. This leaves a portion of the base substrate 24 surrounding the printable substrate 26, so the printable substrate 24 can be gripped independently of the base substrate 24 to assist its manual retraction and removal. The removable portion of the printable article 22 functions as a transferable label and can be used as a sticker, seal, reminder, shipping label, or game piece.

Alternatively, the release layer 30 could be applied to the bottom surface 42 of the printable substrate 26 and the pressure-sensitive adhesive layer 38 could be applied to the top surface 34 of the base substrate 24. This would allow the printable substrate 24 to be removed from the base substrate 26 without carrying an adhesive backing. The pressure sensitive adhesive layer could also be arranged to form a strong bond with the base substrate 24 and a much weaker bond with the printable substrate 26, i.e., a limited tack, allowing the printable substrate 26 to be cleanly removed.

In FIG. 4, a printed article 52 also has a laminate construction including a base substrate 54 and a printable substrate 56. A pressure-sensitive adhesive layer 58 forms a permanent bond between a bottom surface 62 of the base substrate 54 and the inner surface 18 of the label wrap 12. A dry-release adhesive layer 68 forms a temporary bond between a top surface 64 of the base substrate 54 and a bottom surface 72 of the printable substrate 56. The dry-release adhesive can 68 can be applied to either substrate 54 or 56 in a liquid state or uncured state prior to lamination and then converted to a solid or cured form by heat, drying, radiation or chemical reaction. Examples of such dry-release adhesives, also referred to as clean-release adhesives, are disclosed in U.S. Pat. No. 5,039,652 to Doll et al., which is hereby incorporated by reference. A print layer 70 containing graphics or other information relevant to the function of the printed article 52 is formed on a top surface 74 of the printable substrate 56.

The dry-release adhesive layer 68 is preferably applied in a pattern to leave a limited area between the substrates 54 and 56 unbonded so as to from a tab 76 to assist the manual retraction and removal of the printable substrate 56. The dry-release adhesive layer 68 has a limited cohesive strength that is strong enough to hold the printable substrate 56 in place behind the label wrap 12, but is weak enough to allow the printable substrate 56 to be delaminated with ordinary release levels. In addition, the dry-release preferably leaves no tacky residue on the bottom surface 72 of the printable substrate 56. The removable portion of the printable article 52 can be arranged as a coupon, scratch-off, give-away, collectible card, web or net decoder, or other printed promotional article.

The base substrates 24 and 54 of the preceding embodiments provide for a more consistent and predictable base from which the printable substrates 26 or 56 can be later removed. The label wrap 12 is generally made from materials chosen by the product manufacturers for purposes of displaying product information and may not be universally acceptable as a release surface. The adhesive characteristics of the label wrap 12 could vary in unpredictable ways, which could change release levels or the label wrap 12 could be too thin or weak to support a consistent clean release.

In FIG. 5, a printed article 82 has en elemental form that exploits static electricity as a bonding mechanism. A single printable substrate 84 is formed from a thin film having a bottom surface 86 that is treatable together with the inner surface 18 of the label wrap 12 to form the static electric bond. The two surface 18 and 86 are preferably clean and smooth and have a static charges induced between them causing electrical attraction referred to as “static cling”. A print layer 90 on a top surface 88 of the printable substrate 84 includes graphics or other information related to the printed article's intended use, which can be similar to that of the preceding embodiments and includes use as a decal.

The assembled label wrap 12 including the printable substrate 84 is intended to be rewound into a roll prior to use as a feed stock for a labeling machine. Accordingly, the top surface 88 of the printable substrate 84 and the outer surface 16 of the label wrap 12 are relatively treated to avoid similar static cling that could render ambiguous which surface of the label wrap 12 the printable substrate 84 is most attached.

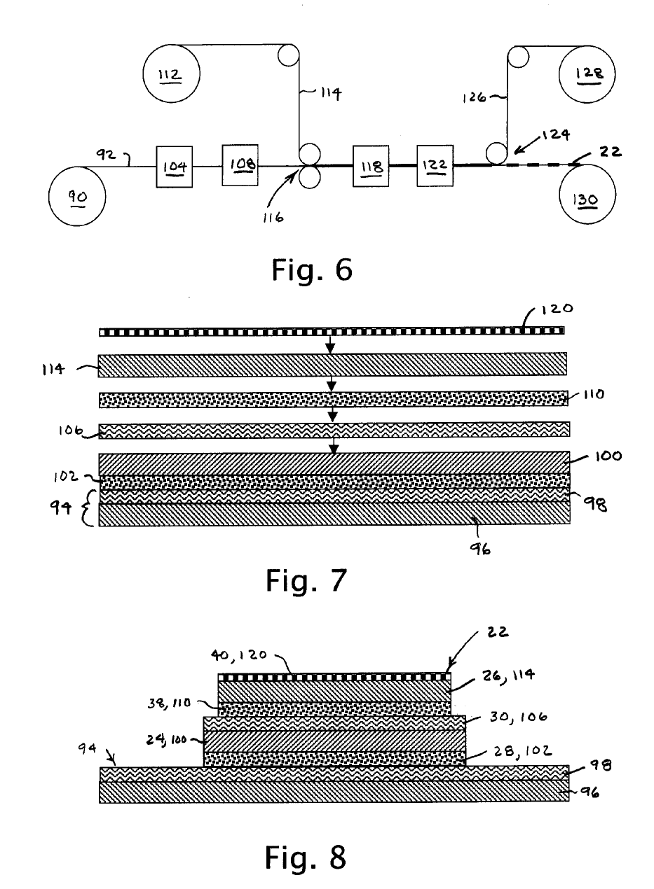

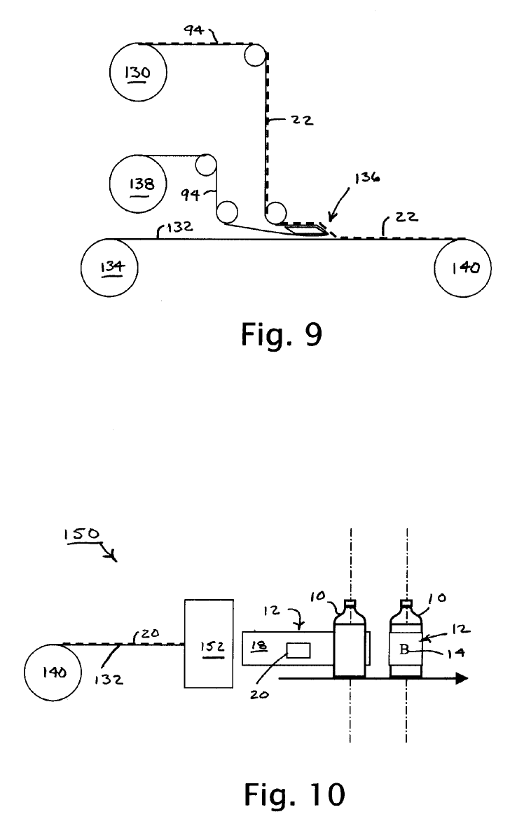

FIGS. 6 and 9 show successive in-line processes for making a succession of printed articles, such as the printed article 22 of FIG. 3, along a liner web 94 and for applying the printed articles 22 from the liner web 94 onto a wrapping web 132, which can be sectioned for forming the label wrap 12. Unwound from a roll 90 is a two-ply label stock web 92, which includes, as shown in FIG. 7, a liner 96 having a release layer 98 and a base substrate 100, such as the base substrate 24, having a pressure-sensitive adhesive layer 102, such as the pressure-sensitive adhesive layer 28, releaseably bonded to the liner 96. Applicator station 104 applies a release layer 106, such as the release layer 30, to the top surface of the base substrate 100. Applicator station 108 applies a patterned adhesive layer 110, such as the pressure-sensitive-adhesive layer 38, to the release layer 106 on the base substrate 100.

Unwound from a roll 112 is a single-ply face stock web 114, such as the printable substrate 26. A laminating station 116 joins the two webs 92 and 114 together through the patterned adhesive layer 110. Curing of the adhesive layer 110, such as by cooling, drying, or irradiating, can take place before or after lamination at the station 116 in accordance with the requirements of the adhesive. Print station 118 prints a print layer 120, such as the print layer 40, on the top surface of the printable substrate 114 according to the purposes of the printed articles 22, and die cut station 122 performs one or more die cuts to in registration with the printing to shape and separate the printed articles 22. A delaminating station 124 strips the unwanted matrix 108 containing portions of both substrates 100 and 114 and winds the unwanted matrix 126 into a roll 128. The printed articles 22 carried on the liner web 94 are wound into another roll 130.

For making the printed articles 52 of FIG. 4, a similar process can be followed, except that the release layer 106 is not needed in advance of pattern coating of the dry-release adhesive 68 on the base substrate 100. The print pattern of the adhesive 68 also changes along with the pattern of die cuts.

The in-line process shown in FIG. 9 mounts the printed articles 22 onto the wrapping web 132, which is later sectioned into the label wrap 12. The liner web 94 supporting a succession of printed articles 22 is unwound from the roll 130, and the wrapping web 132 is unwound from a roll 134. An applicator station 136 transfers the printed articles 22 onto the wrapping web 132 and both webs 94 and 132 are rewound onto rolls 138 and 140. The rewound wrapping web 132 now supports the printed articles 22 in the form shown by FIG. 3 and can be loaded into a conventional wrap labeling machine for application to products. A similar in-line process can be used for mounting the printed articles 52 and 82 of FIGS. 4 and 5 onto the wrapping web 132. However, for the embodiment of FIG. 5, static electric treatments are performed for temporarily securing the printable substrate 84 onto the wrapping web 132.

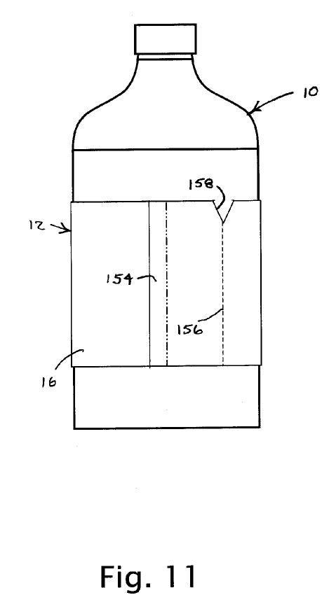

Within a conventional label wrapping/applicator machine 150, as shown in FIG. 10, the wrapping web 132 is severed at station 152 to discrete lengths as the label wraps 12, wrapped around the bottle 10, and sealed so that the printed articles 20 (e.g., printed articles 22, 52, or 82) are positioned between the label wraps 12 and the bottle 10. The product labeling information 14 remains visible on the outside bottle 10.

Although shown occupying a relatively small percentage of the label wrap 12 of FIG. 1, the printed articles 20 can occupy one-third of more of the label wrap 12. More than one printed article 20 can be applied to the inner surface 18 of each label wrap 12. Preferably, both the label wrap 12 and the printable articles 20 are printable, such as by in-line press operations (e.g., flexographic printing). The label wrap 12 can be opaque by virtue of being made of an opaque material or by being printed with opaque ink for obscuring the underlying printed article 20 or can be transparent or translucent for revealing the underlying printed article 20. For example, a clear wrap can be provided with a print window through which the underlying printable article 20 is visible. Information printed onto a bottom surface 32 or 62 of the base substrate 24 or 54 or the bottom surface 42, 72, or 86 of the printable substrate 26, 56, or 84 could be rendered visible through such a window in the label wrap 12.

Once the printed article 20 is mounted on the label wrap 12, the wrap 12 can be applied as usual to the bottle 10 or other product. For example, a stripe of adhesive can be applied to the wrap within a region of overlap 154 as shown in FIG. 11 for securing ends of the label wrap 12 to each other. Another stripe of adhesive (not shown) can be applied to the product to secure the wrap to the product. Heat sealing and other forms of attachment can also be used for applying the label wrap 12 securely to the bottle 10. In addition, the label wrap 12 can be applied as a heat-shrinkable sleeve.

The printed article 20 is preferably accessible by at least partially removing the label wrap 12 from the bottle 10 or other product. Generally, this is expected to involve tearing the label wrap 12 away from the bottle 10. Lines of perforation or weakening 156 can be formed in the label wrap 12 to assist its removal. A notch or nick 158 can also be formed in the label wrap 12 to help start the tear. The printed articles 12 can also be used to assist in the removal of the label wrap 12 by providing protruding portions (not shown) that can be gripped for pulling the label wrap 12 from the bottle 10 or other product. The protruding portion can extend beyond the width of the label wrap 12 or can extend through a circumferential interface or seam between the overlapping ends of the label wrap 12. Preferably, the label wrap 12 surrounds the entire circumference of the bottle 10 or other product but can also be applied to lesser portions of the circumference. Any intended tearing or other damage to the label wrap 12 is preferably apart from the printed article, which can be used to reinforce a portion of the label wrap.

Although described with respect to its preferred embodiments, those of skill in the art will appreciate that a wide variety of modifications can be made in accordance with the teachings of this invention.

1. A product labeling system with overwrapped printed articles, comprising:
a web having a continuous length and inner and outer surfaces;
product labeling information being visible at the outer surface of the web;
a succession of base substrates positioned along the continuous length of the web;
a first adhesive permanently bonding the base substrates to the inner surface of the web;
printable substrates mounted on the succession of base substrates;
a second adhesive temporarily bonding the printable substrates to the base substrates on the inner surface of the web; and
successive lengths of the web being separable into discrete sections for wrapping around products such that the product labeling information remains visible on the products and the printable substrates are located between the wrapped web sections and the products.

2. The system of claim 1 in which the second adhesive is a dry release adhesive so that the printable substrates can be separated from the base substrates without retaining a tacky residue from the temporary adhesive.

3. The system of claim 1 further comprising a release layer in contact with the second adhesive between printable substrates and the succession of base substrates on the inner surface of the continuous web.

4. The system of claim 2 in which the release layer is located between the second adhesive and the base substrates.

5. The system of claim 4 in which the second adhesive is a pressure-sensitive adhesive that is releasable from the release layer of the liner and bondable to another substrate.

6. The system of claim 1 in which the printable substrates overlay the base substrates throughout contiguous areas and the second adhesive is pattern coated over less than the contiguous areas to provide a tab for manually removing the printable substrates from the base substrates.

7. The system of claim 1 in which the printable substrates occupy areas that are less than areas occupied by the base substrates so that a portion of the base substrate extends beyond the printable substrates so that the printable substrates are more readily removable.

8. The system of claim 1 in which the printable substrates occupy limited portions of the discrete web sections.

9. The system of claim 8 in which the discrete web sections encompass the entire peripheries of the products around which the discrete web sections are wrapped.

10. The system of claim 9 in which the discrete web sections have opposite ends that are sealed together to encompass peripheries of the product.

11. A product labeling system with promotional article comprising:
a film web having outer and inner surfaces and being printed in a repeating pattern along a continuous length;
the printed patterns being visible on the outer surface of the film web for labeling products;
a succession of printable film substrates having front and back surfaces, and being positioned along the length of the web in registration with the repeating patterns; and
the back surface of the printable film substrate being treated together with the inner surface of the film web to generate a static electric bond for securing the printable film substrates to the inner surface of the film web.

12. The system of claim 11 in which the film web is wound together with the succession of printable film substrates into a roll, and the front surface of the printable film substrates is treated to avoid statically bonding with the outer surface of the film web so that the printable film substrates remain statically bonded to the inner surface of the film web when the film web is unrolled.

13. The system of claim 11 in which successive lengths of the film web are separated into discrete sections in registration with the printed patterns.

14. The system of claim 13 in which the web sections are wrapped around products such that the product patterns remain visible on the products and the printable film substrates are located between the wrapped web sections and the products.

15. A method of labeling products comprising:
advancing a wrapping web having a continuous length and inner and outer surfaces along a first in-line apparatus, printed patterns being visible on the outer surface of the wrapping web for labeling products;
advancing a liner web having a continuous length and a succession of printed articles distributed along the continuous length of the liner web,
transferring the printed articles from the liner web to the wrapping web;
bonding the printed articles to the inner surface of the wrapping web;
advancing the wrapping web together with the bonded printed articles along a second in-line apparatus;
separating the wrapping web into discrete sections each containing at least one of the printed articles; and
wrapping the discrete web sections around products such that the printed patterns remain visible on the products and the printable articles are located between the wrapped web sections and the products.

16. The method of claim 15 in which the printed articles include base substrates temporarily mounted on the liner web and printable substrates temporarily mounted on the base substrates.

17. The method of claim 16 in which the step of bonding the printed articles includes permanently bonding the base substrates to the inner surface of the wrapping web.

18. A product wrapping system comprising:
a printed label wrap that is wrapped around a circumference of a product;
an outer surface of the label wrap being oriented remote from the product for presenting printed information about the product;
an inner surface of the label wrap being oriented adjacent to the product;
a printed article being temporarily bonded to the inner surface of the label wrap and being located between the label wrap and the product so that the label wrap must be permanently altered to detach at least a portion of the printed article from the inner surface of the label wrap.

19. The system of claim 18 in with the label wrap includes a length having two ends that are bonded together to secure the label wrap to the product.

20. The system of claim 18 in which the printed article includes a base substrate that is permanently bonded to the inner surface of the label wrap and a printed substrate that is temporarily bonded to the base substrate.

21. The system of claim 18 in which the printed article is visible through the label wrap.
